(19) United States
(12) Patent Application Publication
(10) Pub. No.: US 2023/0132219 A1
(43) Pub. Date: Apr. 27, 2023

(54) CONVEYOR SYSTEM, USE OF A SPRING DAMPER ASSEMBLY IN AN ENDLESS CONVEYOR TENSIONER ASSEMBLY, AND USE OF A CONVEYOR SYSTEM IN CROP CULTIVATION

(71) Applicant: WPS Horti Systems B.V., De Lier (NL)

(72) Inventors: Martinus Johannes Josephus Van Der Salm, Honselersdijk (NL); Max Jeroen Krijger, Zwijndrecht (NL)

(21) Appl. No.: 17/798,091

(22) PCT Filed: Feb. 5, 2021
(86) PCT No.: PCT/NL2021/050077

§ 371 Date: Aug. 8, 2022

(30) Foreign Application Priority Data
Feb. 7, 2020 (NL) 2024857

(51) Int. Cl. B65G 23/44

(52) U.S. Cl. CPC B65G 23/44

(57) ABSTRACT

A conveyor belt system includes a frame, a plurality of rollers supported by the frame, an endless conveyor belt, and at least one tensioning assembly, where the conveyor belt is tensioned in the frame while passing over the rollers, and where the at least one tensioning assembly is configured to tension the conveyor belt. The tensioning assembly includes a spring/absorber assembly with a shock absorber and at least one spring. The shock absorber and at least one spring extend between a first end part and a second end part with the at least one spring being set in parallel to the shock absorber. Use of the spring/absorber assembly in a tensioning assembly for an endless conveyor belt reduces slip-stick. The conveyor belt system is useful when growing plants.

### CROSS-REFERENCE TO RELATED APPLICATIONS

This application is the National Stage of International Application No. PCT/NL2021/050077, filed Feb. 5, 2021, which claims the benefit of Netherlands Application No. 2024857, filed Feb. 7, 2020, the contents of which is incorporated by reference herein.

### FIELD OF THE INVENTION

The present invention relates generally to a conveyor belt system.

### BACKGROUND OF THE INVENTION

The problem of stick-slip is encountered with conveyor belts which have a relatively large length. At lower speeds, the stick-slip problem generally occurs more often or sooner than at higher speeds.

Stick-slip, also referred to as slip-stick, is the phenomenon of a jolty movement which occurs when two abutting objects start to slide with respect to each other. The sliding starts as soon as the maximum static friction has been overcome. At that moment, the coefficient of friction changes from the static to the—- lower - dynamic coefficient of friction, which is accompanied by a jolt.

With a conveyor belt system, stick-slip occurs when the drive roll which causes the conveying movement of the conveyor belt slips with respect to the conveyor belt. With a conveyor belt system, the drive roll and conveyor belt will alternately stick to each other—- the so-called sticking - and slide with respect to each other - the so-called slipping - because every time a jolt occurs due to the drive roll and conveyor belt detaching - causing slip - the drive roll and conveyor belt return to a slip-less state, from which the frictional force builds up again until the maximum static friction is reached again and a subsequent detachment - causing slip -occurs. This results in repeated jolts and may, inter alia, lead to a longitudinal vibration in the conveyor belt. This is undesirable and may lead to all kinds of problems.

Stick-slip also occurs in a conveyor belt whose conveying portion extends across a support surface which is stationary with respect to the conveyor belt. This occurs very often, for example, in horticulture. Due to the sandy and often also moist or wet environment, corotating support rollers—- which would prevent slip-stick - are preferably avoided here. A support surface which is stationary with respect to the conveyor belt is therefore often used in horticulture. There may be a greater occurrence of slip-stick in horticulture when there is water present between the conveyor belt and the stationary support surface. Due to the presence of the water, a suction effect or vacuum effect may occur. In this case, slip-stick is counteracted by measures such as supporting ribs, grooves or other uneven structures in the support surface which reduce the contact between the conveyor belt and the support surface. However, stick-slip still occurs in cases where the length of the conveyor belt system is too long. In addition, the low speeds at which the conveyor belt systems in the horticultural sector rotate—- usually less than 25 metres per minute, often between 12 and 20 metres per minute or even slower - are conducive to stick-slip.

In horticulture, conveyor belt systems are used, inter alia, for displacing and/or growing plants. In horticulture, conveyor belt systems for displacement can be subdivided into, inter alia, 3 groups, namely conveying systems, sorting systems and delivery systems.

Problems encountered in horticulture when jolts caused by stick-slip occur include the following:
Plants fall over. They then have to be put back up or have to be removed if they are damaged;
The growing medium, such as potting soil or another substrate, is removed from the pot due to shaking. This results in soiling of the conveyor track and may furthermore also lead to damage to (the roots of) the plants.
The intermediate distance—- also referred to as pitch - between successive plants changes, leading to problems with the automated handling of the plants. For example, the action of a fork which is able to lift up several plants at the same time will be impaired if the pitch is changed.

In horticulture, there is a great need for conveyor belts of great lengths, such as 100 metres or often even longer. Furthermore, the conveying speeds are low in this case in order to prevent damage to the conveyed plants. In practice, it has been found that the maximum length of conveyor belt track for one drive mechanism is 70 metres - that is to say an endless conveyor belt with a conveying portion of 70 metres. A conveyor track of for example 100 metres then requires two endless conveyor belts which each require a dedicated drive mechanism. A drive mechanism for a conveyor track with an endless conveyor belt is already expensive in and of itself and is particularly expensive in the case of horticultural applications when one takes into consideration the fact that, in horticulture, an endless conveyor belt is often idle and in many cases for long periods of time. All this becomes even more costly, when several endless conveyor belts are placed one behind the other to cover great lengths.

### SUMMARY OF THE INVENTION

The general aim of the present invention is to prevent the occurrence of stick-slip with endless conveyor belts and/or to reduce the effects thereof, and is aimed more particularly to prevent the occurrence of stick-slip with endless conveyor belts used in horticulture and/or to reduce the effects thereof. The conveying portion of endless conveyor belts used in horticulture is usually supported on a support surface which is stationary with respect to the moving endless conveyor belt.

According to a first aspect of the invention, this aim is achieved by using a spring/absorber assembly in a tensioning assembly for an endless conveyor belt, wherein the spring/absorber assembly comprises a shock absorber and at least one spring, wherein the shock absorber and at least one spring extend between a first end part and a second end part with the at least one spring being set in parallel to the shock absorber.

According to a second aspect of the invention, this aim is achieved by providing a conveyor belt system comprising a frame, a plurality of rollers supported by the frame, an endless conveyor belt, and at least one tensioning assembly, wherein the conveyor belt is tensioned in the frame while passing over the rollers, and wherein the at least one tensioning assembly is configured to tension the conveyor belt, which conveyor belt system is, according to the invention, characterized by the fact that the tensioning assembly comprises a spring/absorber assembly with a shock absorber and at least one spring, and by the fact that the shock absorber and at least one spring extend between a first end part and a second end part with the at least one spring being set in parallel to the shock absorber.

The shock absorber slows down the movement of every jolt and the spring ensures that the effect of the jolt is lessened in the rest of the conveyor belt system. By way of tests, the Applicant has found that the length of a conventional conveyor belt system can readily be extended by approximately 50% by means of a spring/absorber assembly without detrimental consequences of slip-stick and without having to make other essential modifications to the conveyor belt system. Usually, when used in horticulture and with one drive mechanism, conveyor belts with track lengths of up to 60 to 70 metres are achievable, but with a spring/absorber assembly according to the invention, a conveyor belt with a track length of 100 metres and even considerably more than 100 metres can easily be achieved.

According to a further embodiment of the first and second aspect of the invention, the conveying portion of the endless conveyor belt is supported on a support surface which is stationary with respect to the around moving conveyor belt and which extends along essentially the entire length of the conveying portion. The expression essentially the entire length is understood to mean along at least 80% of the length of the conveying portion. The stationary support surface may in this case form part of the frame.

According to a further embodiment of the first and second aspect of the invention, the spring/absorber assembly comprises two said springs and the shock absorber is provided between these two springs. This results in a relatively flat construction in which a spring or shock absorber can be replaced without having to remove the other components. In addition, this construction makes it possible to achieve a uniform distribution of forces, so that the shock absorber is subjected to longitudinal forces and as little as possible to transverse forces which are usually undesirable for a shock absorber.

According to yet a further embodiment of the first and second aspect of the invention, the shock absorber and at least one spring, such as the two abovementioned springs, are attached to the first end part so as to be pivotable about mutually parallel rotation shafts. These rotation shafts are at right angles to the active direction of the shock absorber, that is to say perpendicular to the longitudinal axis of the spring/absorber assembly which extends between the first and second end part and at right angles to the conveying portion of the conveyor belt. This prevents, viewed along the width of the conveyor belt, any variation in the tension of the conveyor belt from having an effect on the shock absorber in the form of an oblique loading. According to an alternative or additional yet further embodiment of the first and second aspect of the invention, the shock absorber and the at least one spring are similarly attached to the second end part so as to be pivotable about mutually parallel rotation shafts.

According to yet a further embodiment of the first and second aspect of the invention, the first end part operationally engages the conveyor belt. When the first end part is displaced in the active direction of the spring/absorber assembly, this will exert a force on the conveyor belt which is not damped by the spring/absorber assembly. Because the conveyor belt has to be able to move when in use, the first end part will generally engage indirectly with the conveyor belt, for example via a slide block. More particularly, according to yet another embodiment of the first and second aspect of the invention, the first end part will engage the conveyor belt via a tension roller. According to yet another embodiment of the first and second aspect of the invention, the tension roller may be fitted in a carriage which is fitted in the frame so as to be slidable at right angles to the rotation axis of the tension roller and parallel to the conveying part of the conveyor belt.

According to a further embodiment of the first and second aspect of the invention, the second end part may also operatively engage the conveyor belt, but on another portion, or with the frame or otherwise with respect to the outside world around the conveyor belt. When the second end part engages the conveyor belt, this may be fitted in a carriage—- in a similar way to that described in connection with the first end part - via for example a slide block or via a tension roller. In case of a tension roller, this may be fitted in a carriage- in a similar way to that described in connection with the first end part - which is fitted in the frame so as to be slidable at right angles to the rotation axis of the tension roller and parallel to the conveying portion of the conveyor belt.

According to yet a further embodiment of the first and second aspect of the invention, the shock absorber is a telescopic shock absorber.

According to yet a further embodiment of the first and second aspect of the invention, the shock absorber comprises a cylinder, a piston rod, and a cylinder provided on the piston rod, with the piston fitting in the cylinder in a form-fitting manner and being movable to and fro in the cylinder.

According to yet a further embodiment of the first and second aspect of the invention, the shock absorber is a hydraulic shock absorber. Any occurring jolts can thus be smoothly absorbed.

According to yet a further embodiment of the first and second aspect of the invention, the at least one spring is a helical spring.

According to yet a further embodiment of the first and second aspect of the invention, the conveyor belt has an upper conveying portion which essentially extends straight from a first return roller to a second return roller, and a lower return part, and the spring/absorber assembly is provided under the conveying portion and the spring/absorber assembly engages the return part. The spring/absorber assembly which, on the one hand, engages the conveying part and, on the other hand, may also engage the return part or with the frame or with the outside world is thus, so to say, provided in the return part or on the return side of the conveyor belt.

According to yet a further embodiment of the first and second aspect of the invention, the length of the conveying portion for each drive mechanism for the endless conveyor belt is at least 80 m, such as at least 90 m or at least 100 m or more. The length of the conveying portion may even be 150 metres or more.

According to yet a further embodiment of the second aspect of the invention, the system furthermore comprises a channel with a bottom and longitudinal side walls rising from the bottom, wherein the conveying portion extends over the bottom of the channel. This system may be used when growing plants. Root containers provided with plants may be placed in the channel and water may be supplied to the root containers via the channel. In this way, it is possible to grow the plants on the conveyor belt and in the channel. When the plants have grown sufficiently, have to be inspected or have to be moved for any reason, the conveyor belt can be activated in order to convey the root containers containing the plants to one end of the channel.

According to a third aspect of the invention, the invention provides the use of a conveyor belt system according to the second aspect of the invention when growing plants, wherein a plurality of root containers provided with plants are placed on the conveyor belt.

### BRIEF DESCRIPTION OF THE DRAWINGS

The present invention will be explained in more detail by means of the diagrammatic examples of embodiments illustrated in the following figures, in which:

FIG. 1 diagrammatically shows a perspective view, partly with the parts separated, of a tensioning system according to the invention comprising a spring/absorber assembly according to the invention;

FIG. 2 shows a highly diagrammatic representation of a first embodiment of the conveying system according to the invention; and

FIG. 3 shows a highly diagrammatic representation of a second embodiment of the conveying system according to the invention.

### DETAILED DESCRIPTION OF THE INVENTION

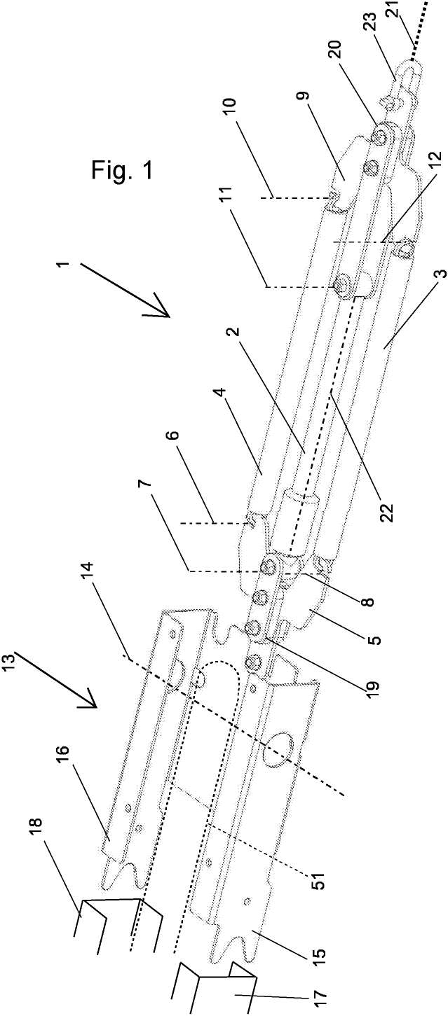

FIG. 1 shows a tensioning assembly according to the invention provided with a spring/absorber assembly 1 according to the invention.

The spring/absorber assembly 1 comprises a shock absorber 2 and at least one spring 3, 4, in this example two springs 3 and 4. The shock absorber 2 is arranged between the springs 3 and 4 and has an active direction—- regarding the damping action - which coincides with the direction in which the longitudinal axis 22 of the shock absorber extends. Disregarding the thickness of shock absorber 2 and springs 3, 4, the shock absorber 2 and the springs 3, 4 are situated in one flat plane in this example.

The shock absorber 2 and at least one spring 3, 4 extend between a first end part 5 and a second end part 9. With regard to operation, the at least one spring 3, 4 is placed in parallel to the absorber 2. This may be achieved by providing, as is shown in the example from FIG. 1, one or more springs—- in this example two springs - next and parallel to the absorber, but this may also be achieved in a different way, for example by accommodating a spring in the absorber 2 or by using a helical spring and accommodating the absorber in the helical spring.

In this example, the shock absorber 2 is attached to the first end part 5 so as to be pivotable about rotation axis 7. Additionally, the at least one spring 3, 4 may also be attached to the first end part 5 so as to be pivotable about a rotation axis 6, 8, but this is not obligatory. If the at least one spring 3, 4 is attached to the first end part 5 so as to be pivotable about the rotation axis 6,8, then the rotation axis 6, 8 of the at least one spring 3,4 is, in particular, parallel with the rotation axis 7 of the shock absorber 2.

In this example, the shock absorber 2 is attached to the second end part 9 so as to be pivotable about rotation axis 11. Additionally, the at least one spring 3, 4 may also be attached to the second end part 9 so as to be pivotable about a rotation axis 10, 12, but this is not obligatory. If the at least one spring 3, 4 is attached to the second end part 9 so as to be pivotable about the rotation axis 10, 12, then the rotation axis 10, 12 of the at least one spring 3, 4 is, in particular, parallel with the rotation axis 11 of the shock absorber 2.

It should be noted that the fastening of the shock absorber 2 and the at least one spring 3, 4 to the first end part 5 and/or to the second end part 9 may also differ from that described above.

The first end part 5 engages the conveyor belt 51 which is diagrammatically shown in FIG. 1 by means of a dashed line. In the example from FIG. 1, this engagement occurs by means of a tension roller which is diagrammatically indicated in FIG. 1 by the longitudinal axis 14 of the tension roller, about which the tension roller can also rotate.

In the example from FIG. 1, the tension roller 14 is accommodated in a carriage 13 belonging to the tensioning assembly which has two sliding parts 15 and 16. These sliding parts cooperate with rails 17, 18 which form part of the frame of a conveyor belt system. The sliding parts 15 and 16 are displaceable along these rails 17 and 18 in a direction which is approximately parallel to that of the longitudinal axis 22. The first end part 5 is attached to the carriage 13 at reference numeral 19. This fastening may be a rigid fastening, but may also be achieved by means of rotation about an axis parallel with or at right angles to the rotation axis 7 of the pivot fastening with which the shock absorber 2 is attached to the first end part.

The second end part 9 may engage the conveyor belt in a way similar to the first end part 5 via a tension roller (not shown). This tension roller may be attached to a carriage which is slidable over rails in a way similar to that described above with respect to the first end part 5 (not shown).

However, the second end part 9 may also be attached to frame of a conveyor belt assembly (not shown in FIG. 1) by means of its fastening point 20. This may be a direct fastening (fastening point 20 attached directly to the frame) or an indirect fastening, for example via the pivotable bracket 23 shown in FIG. 1 or via a tension cable 21 indicated diagrammatically in FIG. 1 or via the bracket 23 in combination with the tension cable 21 or in yet another way.

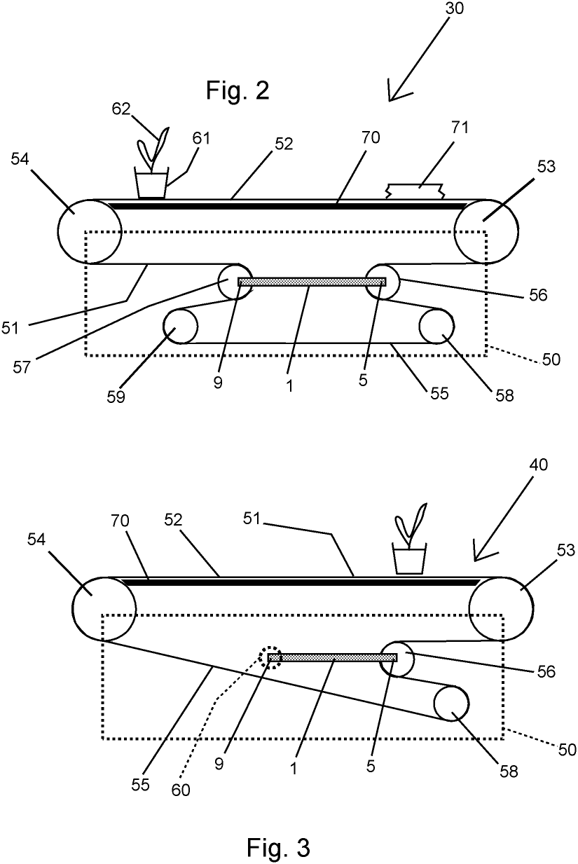

FIG. 2 shows a highly diagrammatic side view of an example of a first embodiment of a conveyor belt system 30 according to the invention. This conveyor belt system comprises a frame 50 which is diagrammatically indicated by a rectangle using a dotted line, a plurality of rollers 53, 54, 56, 57, 58 and 59 which are supported by the frame 50, an endless conveyor belt 51 which is tensioned in the frame while passing over the rollers 53, 54, 56, 57, 58 and 59, and at least one tensioning system comprising a spring/absorber assembly 1 according to the invention, for example a spring/absorber assembly as illustrated in FIG. 1 with a carriage 13 at both ends which is slidable along rails 17, 18 which are provided on the frame 50.

The rollers 53 and 54 are return rollers between which the—- in this example upper - conveying portion 52 of the endless conveyor belt 51 extends. One of these return rollers may be driven in order to rotate the endless conveyor belt 51. However, it is also conceivable for both return rollers 53, 54 to be driven in order to rotate the endless conveyor belt. However, it is also conceivable for none of these return rollers 53, 54 to be driven. In this case, a different drive mechanism will be provided, for example via the roller 58 and/or the roller 59. The conveying portion 52 runs essentially straight, although this does not exclude a dip or curve at the start of an upward or downward slope and this does not exclude the conveying portion locally being provided with a gap where the conveyor belt is directed downwards in order to be passed over a driven roller or tension roller for the purpose of driving or tensioning the endless conveyor belt.

In the example from FIG. 2, the conveying portion 52 is supported by a stationary support surface 70. This support surface 70 may be subjected to a vibration, but is otherwise essentially stationary with respect to the continuous conveying movement of the conveyor belt. This support surface 70 may be formed by the bottom of a channel, a portion of one of the upright side walls 71 of which is diagrammatically shown in FIG. 2.

The rollers 57 and 56 are both tension rollers between which the tensioning assembly comprising spring/absorber assembly 1 according to the invention is provided and which are movable with respect to the frame 50 in the, in the example from FIG. 2, horizontal direction. In this case, the springs 3 and 4 are pretensioned in order to pull the return rollers 56 and 57 towards each other and thus keep the conveyor belt under tension. The rollers 58 and 59 are in this case fixedly fitted with respect to the frame and have a guiding function and one or both thereof may optionally be driven.

FIG. 3 shows a highly diagrammatic side view of an example of a second embodiment of a conveyor belt system 40 according to the invention. This conveyor belt system 40 differs from the conveyor belt system 30 from FIG. 2 mainly in that i) the rollers 57 and 59 are absent, and ii) the second end part 9 of the spring/absorber assembly 1 engages the frame 50 at reference numeral 60 instead of with the conveyor belt. Referring to FIG. 1, the second end part 9 will then be attached to the frame 50 at fastening point 20 directly or via a bracket 23 and/or tension cable 21 or otherwise. For the rest, the exemplary embodiments from FIG. 2 and FIG. 3 essentially correspond and therefore the same reference numerals as in FIG. 2 have been used in FIG. 3 for corresponding parts.

As is indicated diagrammatically in FIGS. 2 and 3, the conveyor belt system according to the invention is readily usable for growing plants 62 which are situated on the conveyor belt in a root container 61, such as a plant pot or substrate.

As is clear from the highly diagrammatic illustration of the exemplary embodiments in FIGS. 2 and 3, many variants of the conveyor belt system are possible which fall within the scope of the invention defined by the claims.

Also, many variants for the spring/absorber assembly are conceivable which fall within the scope of the use according to the invention defined by the claims.

1. A conveyor belt system comprising a frame, a plurality of rollers supported by the frame, an endless conveyor belt, and at least one tensioning assembly,
wherein the conveyor belt is tensioned in the frame while passing over the rollers, and
wherein the at least one tensioning assembly is configured to tension the conveyor belt,
wherein the tensioning assembly comprises a spring/absorber assembly with a shock absorber and at least one spring, and
wherein the shock absorber and at least one spring extend between a first end part and a second end part with the at least one spring being set in parallel to the shock absorber.

2. Use of a spring/absorber assembly in a tensioning assembly for an endless conveyor belt, wherein the spring/absorber assembly comprises a shock absorber and at least one spring, wherein the shock absorber and at least one spring extend between a first end part and a second end part with the at least one spring being set in parallel to the shock absorber.

3. The system according to claim 1, wherein the conveying portion of the endless conveyor belt is supported on a support surface which is stationary with respect to the around moving conveyor belt and which extends along at least 80% of the length of the conveying portion.

4. The system according to claim 1, wherein the spring/absorber assembly comprises two said springs, and wherein the shock absorber is provided between these two springs.

5. The system according to claim 1, wherein the shock absorber and at least one spring are attached to the first end part so as to be pivotable about mutually parallel rotation shafts.

6. The system according to claim 1, wherein the shock absorber and the at least one spring are attached to the second end part so as to be pivotable about mutually parallel rotation shafts.

7. The system according to claim 1, wherein the first end part engages the conveyor belt.

8. The system according to claim 7, wherein the first end part engages the conveyor belt via a tension roller.

9. The system according to claim 8, wherein the tension roller is fitted in a carriage which is fitted in the frame so as to be slidable at right angles to the rotation axis of the tension roller and parallel to the conveying part of the conveyor belt.

10. The system according to claim 7, wherein the second end part engages the conveyor belt.

11. The system according to claim 10, wherein the second end part engages the conveyor belt via a tension roller.

12. The system according to claim 11, wherein the tension roller is fitted in a carriage which is fitted in the frame so as to be slidable at right angles to the rotation axis of the tension roller and parallel to the conveying part of the conveyor belt.

13. The system according to claim 7, wherein the second end part engages the frame.

14. The system according to claim 1, wherein the shock absorber is a telescopic shock absorber.

15. The system according to claim 1, wherein the shock absorber comprises a cylinder, a piston rod, and a cylinder provided on the piston rod, with the piston fitting in the cylinder in a form-fitting manner and being movable to and fro in the cylinder.

16. The system according to claim 1, wherein the shock absorber is a hydraulic shock absorber.

17. The system according to claim 1, wherein the spring is a helical spring.

18. The system according to claim 1, wherein the conveyor belt has an upper conveying portion which extends essentially straight from a first return roller up to a second return roller, and has a lower return part, and wherein the spring/absorber assembly is provided under the conveying portion and engages the return part.

19. The system according to claim 18, wherein the length of the conveying portion for each drive mechanism for the endless conveyor belt is at least 80 m, such as at least 90 m or at least 100 m or more.

20. The system according to claim 18, furthermore comprising a channel with a bottom and longitudinal side walls rising from the bottom, wherein the conveying portion extends over the bottom of the channel.

21. Use of a conveyor belt system according to claim 1, when growing plants, wherein a plurality of root containers provided with plants are placed on the conveyor belt.
